(19) United States
(12) Patent Application Publication
(10) Pub. No.: US 2026/0099343 A1
(43) Pub. Date: Apr. 9, 2026

(54) END USER ENHANCEMENT OF SOFTWARE SERVICES

(71) Applicant: UKG Inc., Weston, FL (US)

(72) Inventor: Adam Menne, Lake St. Louis, MO (US)

(21) Appl. No.: 18/975,507

(22) Filed: Dec. 10, 2024

Related U.S. Application Data
(60) Provisional application No. 63/703,831, filed on Oct. 4, 2024.

(51) Int. Cl. G06F 9/448; G06F 9/48

(52) U.S. Cl. CPC G06F 9/4482; G06F 9/4881

(57) ABSTRACT

A method for end user enhancement of software services includes obtaining first custom enhancement data indicating one or more phases for performing a task defined by the first user. A first phase is associated with a portion of executable code provided by the first client device, and the portion of the executable code operates on data managed by a software application executing on a server device. The method includes storing the first custom enhancement data. The method includes obtaining data indicating user selection of the first custom enhancement data. The method includes performing, by the server device and using the first custom enhancement data, the one or more phases of the task defined by the first user for the second user. Performing the one or more phases of the task includes executing the portion of executable code associated with the first phase of the one or more phases.

### CLAIM OF PRIORTY

The present application claims the benefit under 35 U.S.C. §119(e) of U.S. Provisional Patent Application No. 63/703,831 filed October 4, 2024, which is incorporated by reference herein.

### TECHNICAL FIELD

Embodiments of the present disclosure relate to computing systems, and more specifically, to systems and methods for end user enhancement of software services.

### BACKGROUND

Businesses, especially small-size businesses and medium-size businesses, and non-profit organizations often do not have sufficient computing resources and human personnel to develop software services used to maintain and support such businesses (e.g., human resources services, payroll and other financial services, regulatory compliance services, personnel management services, etc.) fully in-house and often rely on specialized outside developers and providers of these services. Such providers may furnish, to client businesses and organizations, various hardware and software computing resources (e.g., cloud-based and/or local) that automate a significant number of software services tasks.

### BRIEF DESCRIPTION OF THE DRAWINGS

The disclosure is illustrated by way of example, and not by way of limitation, and can be more fully understood with references to the following detailed description when considered in connection with the figures, in which:

FIG. 1 illustrates a high-level component diagram of an example architecture, in accordance with one or more embodiments of the present disclosure.

FIG. 2 illustrates an example method for end user enhancement of software services, in accordance with one or more embodiments of the present disclosure.

FIG. 3 illustrates an example workflow of end user enhancement of software services, in accordance with one or more embodiments of the present disclosure.

FIG. 4 illustrates an example user interface (UI) for end user enhancement of software services, in accordance with one or more embodiments of the present disclosure.

FIG. 5 illustrates another example UI for end user enhancement of software services, in accordance with one or more embodiments of the present disclosure.

FIG. 6 illustrates another example UI for end user enhancement of software services, in accordance with one or more embodiments of the present disclosure.

FIG. 7 illustrates another example UI for end user enhancement of software services, in accordance with one or more embodiments of the present disclosure.

FIG. 8 illustrates another example UI for end user enhancement of software services, in accordance with one or more embodiments of the present disclosure.

FIG. 9 illustrates another example UI for end user enhancement of software services, in accordance with one or more embodiments of the present disclosure.

FIG. 10 illustrates an example artificial intelligence (AI) training subsystem, in accordance with one or more embodiments of the present disclosure.

FIG. 11 illustrates an example AI inference subsystem, in accordance with one or more embodiments of the present disclosure.

FIG. 12 illustrates an example method for providing error-avoidance data, in accordance with one or more embodiments of the present disclosure.

FIG. 13 is a block diagram illustrating a computing system in which implementations of the disclosure can be used.

### DETAILED DESCRIPTION

Software performs tasks programmed by the developer of the software, and end users can use the software to perform those tasks. If an end user of the software desires additional tasks or functionality for the software, the end user can contact the developer of the software and describe the tasks or functionality desired by the end user. The developer can then update the software by programming the tasks or functionality, provided that the developer is willing to do so. Similarly, if the end user of the software encounters an error in the software, the end user can contact the developer of the software, and the developer can update the software by fixing the error in the software’s programming. Updating the software to add the desired tasks or functionality or to fix an error in the software can take days, weeks, or even months. Meanwhile, the end user uses the software without the desired tasks or functionality or with the errors in the software, which degrades the end user’s experience using the software. Furthermore, there is no guarantee that the developer will update the software with the desired tasks, functionality, or bug fixes because the developer may determine that the cost to update the software does not outweigh the benefits provided by updating the software (e.g., because only a single end user is requesting the additional tasks or functionality).

Aspects and implementations of the instant disclosure address the above-mentioned and other challenges of the existing technology by providing systems and methods for end user enhancement of software services. A server device that includes the software application can obtain custom enhancement data provided by a first client device of a first user. The custom enhancement data may include one or more phases for performing a task defined by the first user. The software application may not be configured to or programmed to perform the task. A phase of the one or more phases may be associated with a portion of executable code provided by the first user, and the portion of executable code may be used to perform a portion of the task. The portion of executable code may operate on data managed by the software application executing on the server device. The executable code may include code authored by the first user or code generated by an artificial intelligence (AI) model on behalf of the first user. The server device may obtain data indicating that a second user has selected the custom enhancement data provided by the first user. The server device can perform the one or more phases of the task defined by the first user, which can include executing the portion of executable code associated with a phase of the one or more phases. Thus, the first user may enhance the functionality and capabilities of the software application by provided the custom enhancement to the server device.

The advantages of the disclosed techniques include but are not limited to rapid enhancement of software by end users of the software without contacting or working with the developer of the software. A technical advantage of end users providing the enhancements to the software includes reduced usage of computing and human resources by the developer of the software that otherwise would have been used to develop the enhancements to the software. Advantages of the disclosed techniques include the providing the capability of the end user to use AI to develop the enhancements to the software, which allows non-technical users to provide enhancements to the software. Advantages of the disclosed techniques include enhanced end user satisfaction with the software.

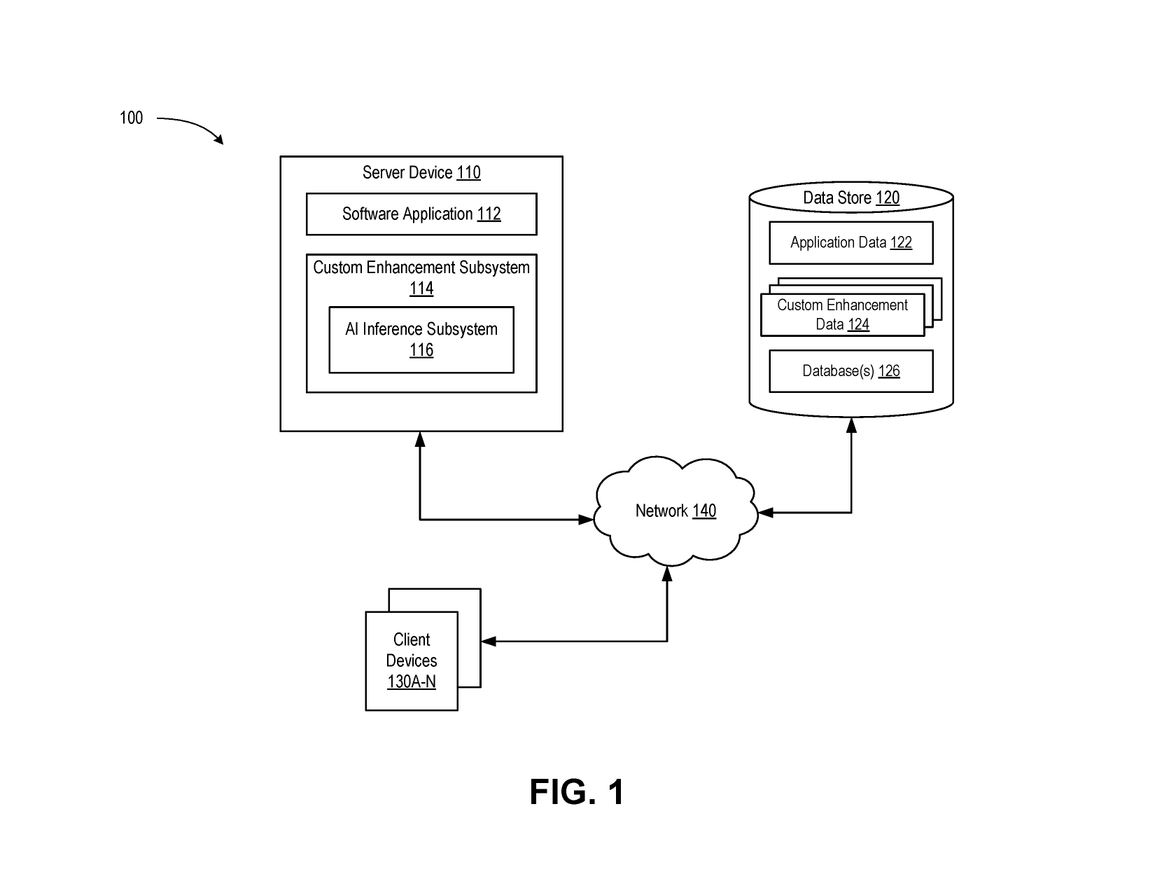

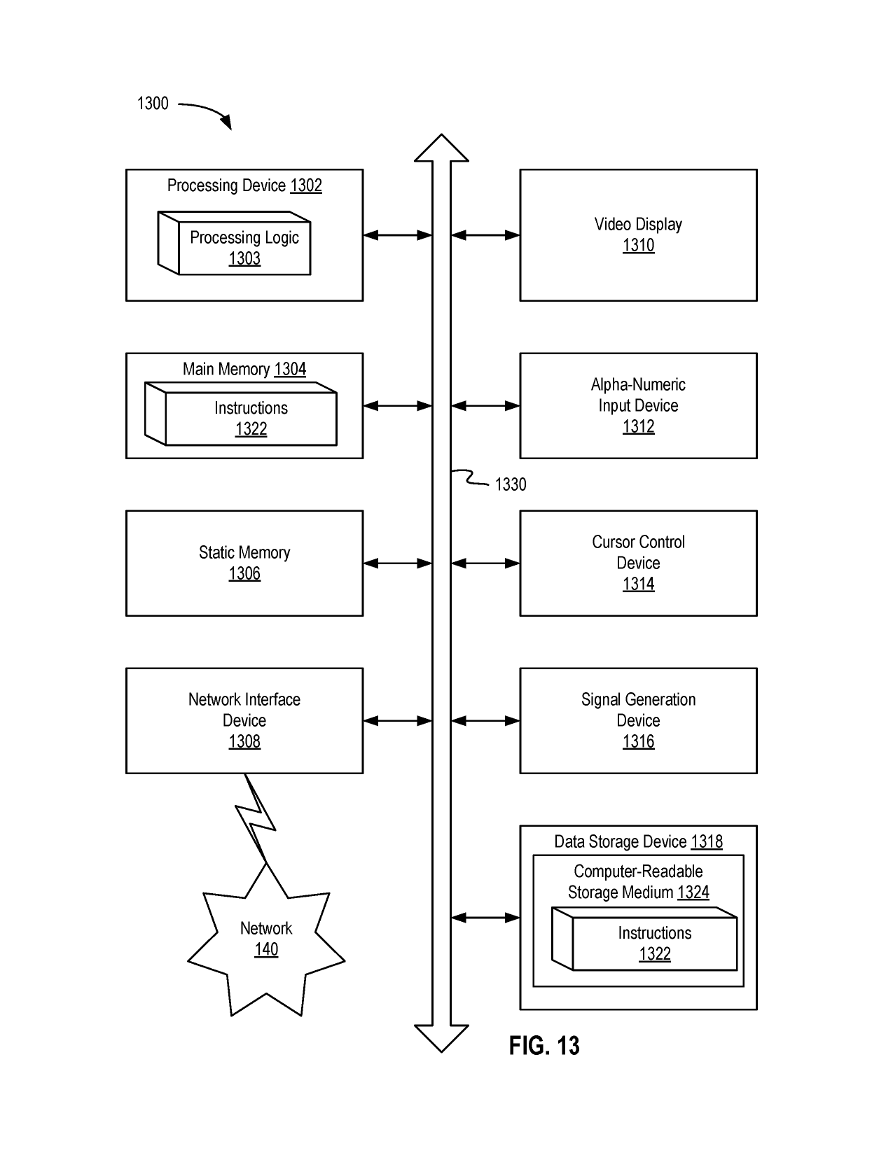

FIG. 1 illustrates a high-level component diagram of an example system architecture 100, in accordance with one or more aspects of the present disclosure. The system architecture 100 (also referred to as the “system” herein) includes a server device 110, a data store 120, one or more client devices 130A-N, and/or other components connected to a network 140. In some embodiments, any of the server device 110 and/or client device(s) 130A-N may include a desktop computer, a laptop computer, a smartphone, a tablet computer, a server, or any suitable computing device capable of performing the techniques described herein. In some embodiments, any of the server device 110 and/or client device(s) 130A-N may be (and/or include) one or more computer systems 1300 of FIG. 13.

In one embodiment, the server device 110 may include a software application 112. The software application 112 may include software that performs one or more tasks or functionality according to the executable code of the software application 112. Examples of software applications 112 that the server device 110 can run may include software services used to maintain and support small- or medium-size businesses (e.g., human resources services, payroll and other financial services, regulatory compliance services, personnel management services, etc.). The software application 112 may include other types of functionalities, operations, or the like for performing other types of tasks. The software application 112 may include a single software program or may include multiple software programs in data communication with each other that collaborate to perform the tasks and functionality of the software application 112.

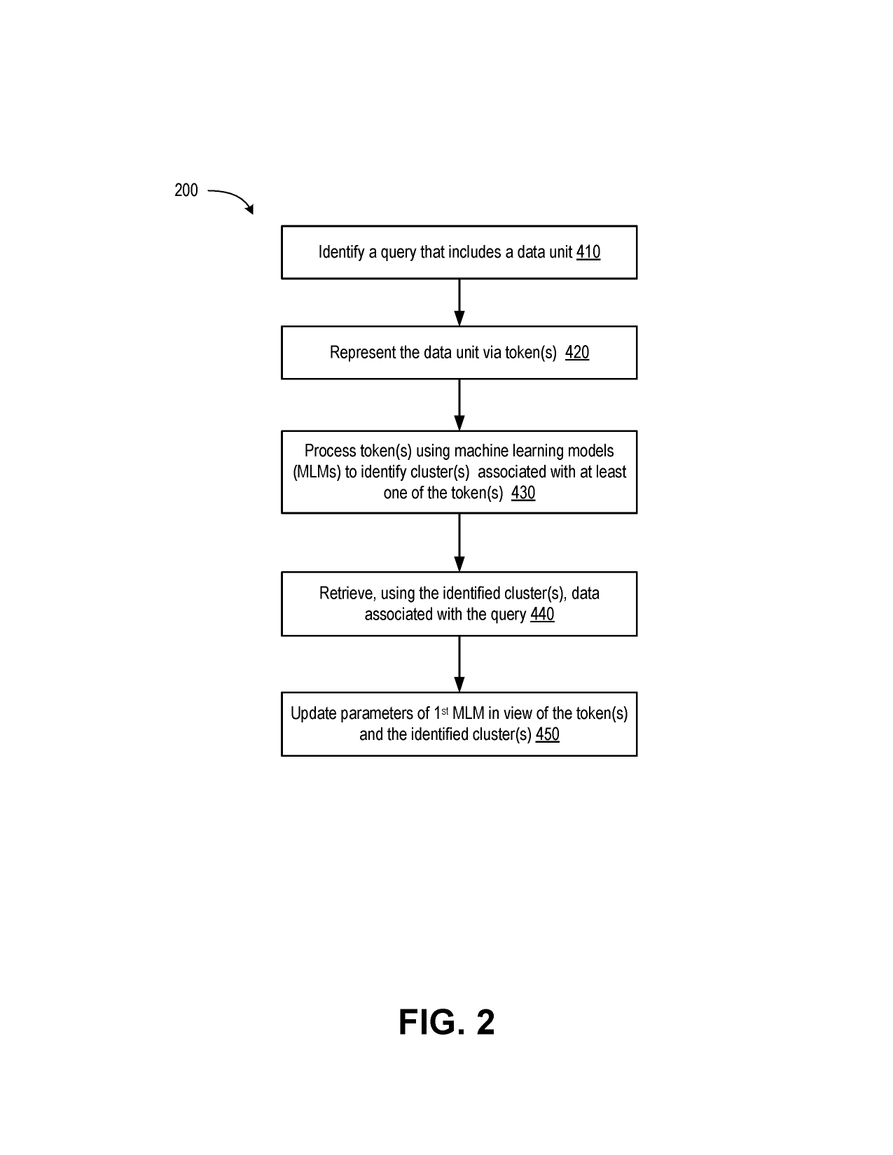

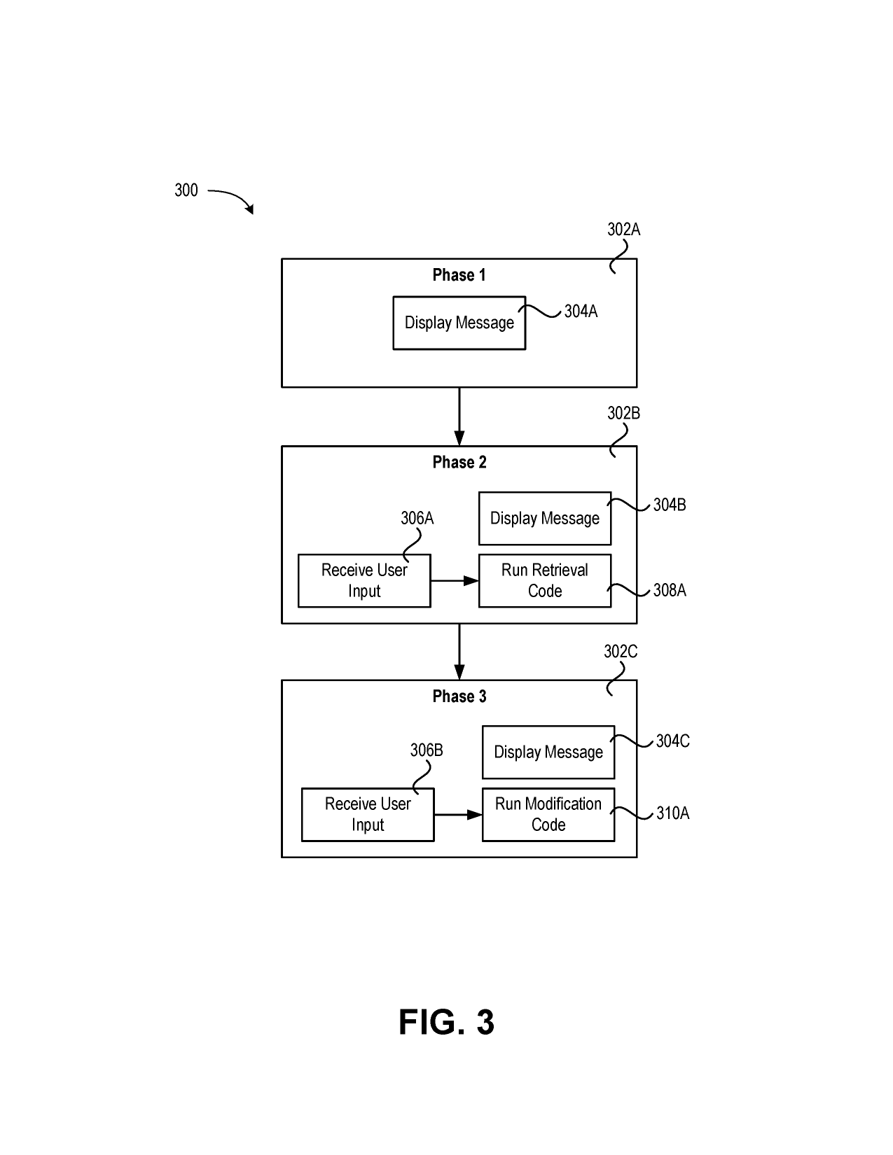

The server device 110 may include a custom enhancement subsystem 114. The custom enhancement subsystem 114 may include software that generates and/or executes custom enhancements. A custom enhancement may enhance (e.g., add to, augment, improve, etc.) the software application 112. A custom enhancement may include data configured or programmed to perform a task that includes one or more phases, and the task may include a task or functionality that the software application 112 does not perform (thus, enhancing the software application 112). Each phase of the custom enhancement may include one or more actions that perform a portion of the task, such as displaying a message associated with the task, executing executable code that retrieves data associated to the task, and/or executing executable code that modifies data associated with the task. Further details regarding custom enhancements are discussed below in relation to FIG. 2 and FIG. 3.

The custom enhancement subsystem 114 may include an AI inference subsystem 116. In one embodiment, the AI inference subsystem 116 may use one or more AI models that can generate executable code for use with a custom enhancement. In some embodiments, the AI inference subsystem 116 may include the one or more AI models. In other embodiments, the AI inference subsystem 116 may include software that is in data communication (e.g., over the network 140) with one or more AI models external to the server device 110 (e.g., AI models hosted by a third-party server device), provides input to the external AI model(s) (e.g., via an application programming interface (API)), and receives responses from the AI model(s). The AI model(s)–whether hosted by the AI inference subsystem 116 or by an external server device–may generate executable code associated with a custom enhancement to the software application 112.

In one embodiment, the data store 120 may be implemented in a persistent storage capable of storing files, data structures, databases, or other data storage formats, in accordance with implementations of the present disclosure. The data store 120 may be hosted by one or more storage devices, such as main memory, magnetic or optical storage disks, tapes, or hard drives, network-attached storage (NAS), a storage area network (SAN), and so forth. Although depicted as separate from the server device 110, the data store 120 may be part of the server device 110 and/or other devices of the system 100.

The data store 120 may store various data and metadata used and/or generated by the software application 112 and/or the custom enhancement subsystem 114. In some embodiments, the data store 120 may store application data 122. The application data 122 may include data and/or metadata used by the software application 112 to perform the tasks and functionality of the software application 112. In some embodiments, the application data 122 may include the executable code executed by a processing device of the server device 110 to execute the software application 112. The data store 120 may store custom enhancement data 124. The custom enhancement data 124 may include data that the custom enhancement subsystem 114 can run to perform the task of a custom enhancement.

The data store 120 may store one or more databases 126. A database 126 may include a structured collection of data that is organized and stored electronically for access and management. A database can include a relational database, an object-oriented database, or some other type of database. The software application 112 may store data in a database 126, retrieve data from the database 126, and modify data in the database 126 as part of performing a task or other functionality. The custom enhancement subsystem 114 may, as part of performing a task indicated by a custom enhancement of the custom enhancement data 124, store data in a database 126, retrieve data from the database 126, and modify data in the database 126. In some embodiments, end users of the client devices 130A-N may belong to different organizations (e.g., different businesses), and different portions of the databases 126 may be accessible to different end users based on which organization an end user belongs to. The server device 110 or a database 126 may enforce security mechanisms to prevent end users from accessing database data that the end user is not authorized to access. Such security mechanisms may include role-based access controls, row-level security, or other similar security mechanisms.

In some embodiments, the network 140 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), and/or the like. In some embodiments, network 140 may include routers, hubs, switches, server computers, and/or a combination thereof.

The software application 112 and/or the custom enhancement subsystem 114 may include (or may have access to) instructions stored on one or more tangible, machine-readable storage media of the server device 110 and may be executable by one or more processing devices of the server device 110. In one embodiment, the software application 112 and/or the custom enhancement subsystem 114 may be implemented as a single component. In some embodiments, the software application 112 and/or the custom enhancement subsystem 114 may each be a client-based application located on a client device 130A-N. The client device 130A-N may include or may be in data communication with the data store 120.

In one embodiment, the software application 112 and/or the custom enhancement subsystem 114 may be a combination of a client component and a server component, with some portions of the software application 112 and/or the custom enhancement subsystem 114 executing on a client device 130A-N while another portion of the software application 112 and/or the custom enhancement subsystem 114 executes on the server device 110. In some embodiments, the software application 112 may form part of a software-as-a-service (SaaS) offering provided by the entity that owns, operates, or controls the software application 112. Users of the one or more client devices 130A-N may access the SaaS offering via an application (e.g., a web browser) running on the respective client devices 130A-N.

FIG. 2 illustrates an example method 200 for end user enhancement of software services, in accordance with some implementations of the present disclosure. A processing device, having one or more central processing units (CPU(s)), one or more graphics processing units (GPU(s)), and/or memory devices communicatively coupled to the one or more CPU(s) and/or GPU(s) can perform the method 200 and/or one or more of the method’s 200 individual functions, routines, subroutines, or operations. In certain embodiments, a single processing thread can perform the method 200. Alternatively, two or more processing threads can perform the method 200, each thread executing one or more individual functions, routines, subroutines, or operations of the method. In an illustrative example, the processing threads implementing the method 200 can be synchronized (e.g., using semaphores, critical sections, and/or other thread synchronization mechanisms). Alternatively, the processing threads implementing the method 200 can be executed asynchronously with respect to each other. Various operations of the method 200 can be performed in a different (e.g., reversed) order compared with the order shown in FIG. 2. Some operations of the method 200 can be performed concurrently with other operations. Some operations can be optional. In some embodiments, the custom enhancement subsystem 114 performs one or more of the operations of the method 200.

At block 210, processing logic obtains first custom enhancement data indicating one or more phases for performing a task defined by a first user. The first custom enhancement data may be obtained from a first client device 130A of the first user. The first user may be associated with a first entity.

As discussed above, a custom enhancement may include data configured or programmed to perform a task that includes one or more phases, and the task may include a task or functionality that the software application 112 does not perform (thus, enhancing the software application 112). The task may be defined by a first user that uses the first client device 130A. The first user may be associated with a first entity, and the first entity may be a customer of a second entity associated with the server device 110. For example, the second entity may include a business that provides software services to the first entity that are used to maintain and support small- or medium-size businesses.

The task defined by the first user may include one or more phases. A phase may include a discrete portion of the task. A first phase of the one or more phases may be associated with a portion of executable code. The portion of executable code may operate on data managed by the software application 112 executing on the server device 110. For example, the portion of executable code may include executable code for retrieving the data managed by the software application 112 (e.g., data stored in the database(s) 126). In another example, the portion of executable code may include executable code for modifying the data managed by the software application 112. The portion of executable code may include a database query. The portion of the executable code may include programming instructions (e.g., source code). The programming instructions may be instructions for a scripting language, compiled language, or another type of programming language. In some embodiments, the portion of executable code may include machine code (e.g., machine code generated from source code).

In one embodiment, the executable code may be provided by the first client device 130A. For example, the first user of the first client device 130A may provide user input to generate the executable code to a UI of the first client device 130A, and the first client device 130A may provide the executable code to the custom enhancement subsystem 114.

In one embodiment, the first user may not have sufficient technical skills to author the portion of executable code. Thus, in order to obtain the executable code, the first user may use an AI model to generate the portion of executable code. The first user may provide user input to the UI of the first client device 130A, and the user input may include text data that includes a command to generate executable code. The text data may describe the desired functionality of the portion of the executable code. The first client device 130A may provide the user input to the custom enhancement subsystem 114. The custom enhancement subsystem 114 may receive, from the first client device 130A, the text data that includes the command to generate executable code. The AI inference subsystem 116 of the custom enhancement subsystem 114 may generate a prompt based on the text data. The prompt may include the command to generate the executable code and may include further information that an AI model can use to generate the executable code (e.g., context information indicating the programming language for the executable code, the names of variables, and other information that AI model can use). The AI inference subsystem 116 may provide the prompt to a generative AI model. As discussed above, the generative AI model may be located on the AI inference subsystem 116 or may be located on a third-party server in data communication with the AI inference subsystem 116. The AI inference subsystem 116 may obtain the portion of executable code from the generative AI model. The AI inference subsystem 116 may provide the portion of executable code to the first client device 130A, for example, in order for the first client device 130A to present the portion of executable code for the first user to review.

At block 220, processing logic stores the first custom enhancement data. The custom enhancement subsystem 114 of the server device 110 may store the first custom enhancement data in the data store 120 as part of the custom enhancement data 124.

In some embodiments, the first custom enhancement data may further include data indicating an availability of the first custom enhancement data to other users of the software application 112. The data indicating the availability may include data indicating that the first custom enhancement is available only to users of the software application 112 that are associated with the first entity (i.e., the entity associated with the first user that authorized the first custom enhancement). The data indicating the availability may include data indicating that the first custom enhancement is available to users of the software application 112 that have a predetermined role. A user of the software application 112 may have one or more roles (as indicated by user profile data managed by the software application 112), such as a payroll representative, a human resources representative, a manager, an executive, or the like. The data indicating the availability may include data indicating that the first custom enhancement is available to all users of the software application 112.

At block 230, processing logic obtains, from a second client device 130B of a second user, data indicating a user selection of the first custom enhancement data. In one embodiment, the software application 112 or the custom enhancement subsystem 114 may provide data to the second client device 130B indicating one or more custom enhancements of the custom enhancement data 124 available to the second client device 130B for use by the second user. The first custom enhancement data may be included in the available one or more custom enhancements. The software application 112 or the custom enhancement subsystem 114 may determine which custom enhancements are available to the second user based on data indicating the availability of the respective custom enhancements, as discussed above. A UI of the second client device 130B may present UI elements indicating the available custom enhancements, and the second user may select the first custom enhancement using the UI. The second client device 130B may provide the selection of the first custom enhancement to the software application 112 or the custom enhancement subsystem 114.

At block 240, processing logic performs, using the first custom enhancement data, the one or more phases of the task defined by the first user for the second user. Performing the one or more phases of the task may include executing the portion of executable code associated with the first phase of the one or more phases.

In one embodiment, a second phase of the one or more phases may include causing a message to be displayed on a UI of the first client device 130A. As discussed above, a phase may include one or more actions the server device 110 can perform as part of the task defined by the first user. As also discussed above, one type of action may include executing executable code, such as executing the portion of executable code associated with the first phase. Other types of actions may include presenting a message to the second user. The message may provide information about the custom enhancement or a phase of the custom enhancement.

In one embodiment, performing the one or more phases may include performing the second phase before the first phase (e.g., causing the message associated with the second phase to be displayed before executing the portion of executable code associated with the first phase). The terms “first phase,” “second phase,” “third phase,” etc., as used herein, do not necessarily imply a temporal order of the phases but are used to distinguish between different phases.

FIG. 3 illustrates an example workflow 300 of a custom enhancement for the software application 112. A custom enhancement may include a custom enhancement that is included in the custom enhancement data 124. The custom enhancement may include the first custom enhancement discussed above in relation to the method 200 of FIG. 2.

The custom enhancement may include one or more phases 302A-C. For example, in the example workflow 300 of FIG. 3, the custom enhancement may include three phases 302A-C. Where a custom enhancement includes multiple phases 302A-C, the phases may include an order of the phases. For example, as seen in FIG. 3, the three phases 302A-C may be in a sequential order. In some embodiments, a first phase 302A may include two or more possible subsequent phases 302B-C, and the workflow 300 may determine which subsequent phase phases 302B-C follows the first phase 302A based on an action that occurs during the first phase 302A.

In one embodiment, a phase 302A-C may include one or more actions. One type of action may include a display message action 304A-C. A display message action 304A-C may include displaying a message on a UI of a client device 130A-N. The message may include text, images, or other data. The message may provide information about the custom enhancement, the current phase 302A-C, or another portion of the custom enhancement. Another type of action may include a receive user input action 306A-B. A user of a client device 130A-N may use the UI of the client device 130A-N to provide user input to the custom enhancement. The user input may include a selection of an option presented by the UI, text data, or other data.

In some embodiments, another type of action may include running retrieval code 308A. A phase 302A-C may include executable code associated with the phase 302A-C. The executable code may include code provided by an authoring user of the custom enhancement. The executable code may include retrieval code, which may include executable code configured and/or programmed to retrieve data from the data store 120. The retrieved data may be used during one or more subsequent phases 302A-C. For example, where the executable code is a Structured Query Language (SQL) query, the retrieval code may include a “select” SQL query. In some embodiments, another type of action may include running modification code 310A. Retrieval code may include executable code configured and/or programmed to modify data in the data store 120. In some embodiments, one or more parameters that specify the data in the data store 120 to be modified may be provided by user input 306A-B or by a result of running retrieval code 308A.

In some embodiments, a phase 302A-C may include a single action (e.g., as seen in the first phase 302A of FIG. 3). A phase 302A-C may include multiple actions (e.g., as seen in the second phase 302B and 302C of FIG. 3). In one or more embodiments, a phase 302A-C may not include a display message action 304A-C or a receive user input action 306A-B.

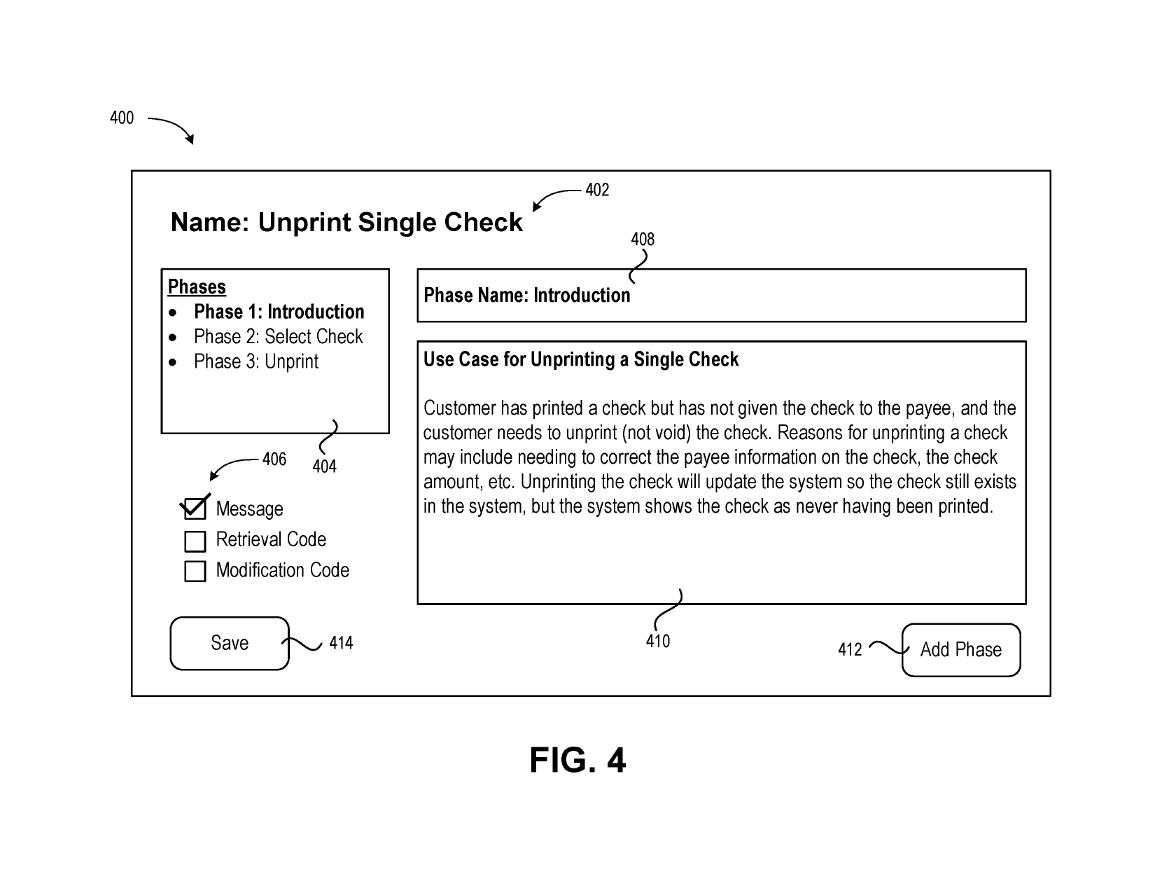

FIGS. 4-6 depict example UIs 400, 500, and 600, respectively, for end user enhancement of software services. The example UIs 400-600 may include UIs for authoring a custom enhancement for the task of unprinting a single check. A first client device 130A of the one or more client devices 130A-N may present the UIs 400-600 on a display of the first client device 130A. The user of the first client device 130A may use the UIs 400-600 to cause the custom enhancement subsystem 114 to generate and store the custom enhancement (e.g., as discussed above in relation to blocks 210 and 220 of the method 200).

As seen in FIG. 4, the UI 400 may include a UI for authoring a first phase 302A of a custom enhancement. The UI 400 may include a name 402 of the custom enhancement. The name 402 may include text indicating the name of the custom enhancement. The UI 400 may include a phase UI element 404. The phase UI element 404 may include text indicating the one or more phases 302A-C of the custom enhancement.

The UI 400 may include an action selection UI element 406. The action selection UI element 406 may include one or more UI elements that a user of the UI 400 can select to include one or more actions in the current phase 302A-C. For example, as seen in FIG. 4, the action selection UI element 406 may include checkboxes that allows the user of the UI 400 to cause the current phase 302A-C to include a message action 304, a retrieval code action 308, or a modification code action 310.

The UI 400 may include a phase name UI element 408 configured to receive user input that indicates the name of the current phase 302A. The phase name UI element 408 may include a text box. The UI 400 may include a message input UI element 410. The message input UI element 410 may include a UI element configured to receive user input that indicates a message to be displayed during the current phase 302A. For example, as seen in FIG. 4, the message input UI element 410 can include a text box. The first user may input text data into the text box for presentation to another using that uses the custom enhancement. For example, as seen in FIG. 4, the text data provides an explanation of the task performed by the custom enhancement. The message input UI element 410 may include other UI elements (e.g., buttons) configured to format or stylize portions of the message, such as UI elements for bolding, underline, italicizing, or highlighting a portion of the message. The UI 400 may include an add phase UI element 412 (e.g., a button) configured to add another phase to the custom enhancement. The UI 400 may include a save UI element 414 (e.g., a button) configured to save the completed custom enhancement and provide the custom enhancement data to the custom enhancement subsystem 114 to be stored in the data store 120.

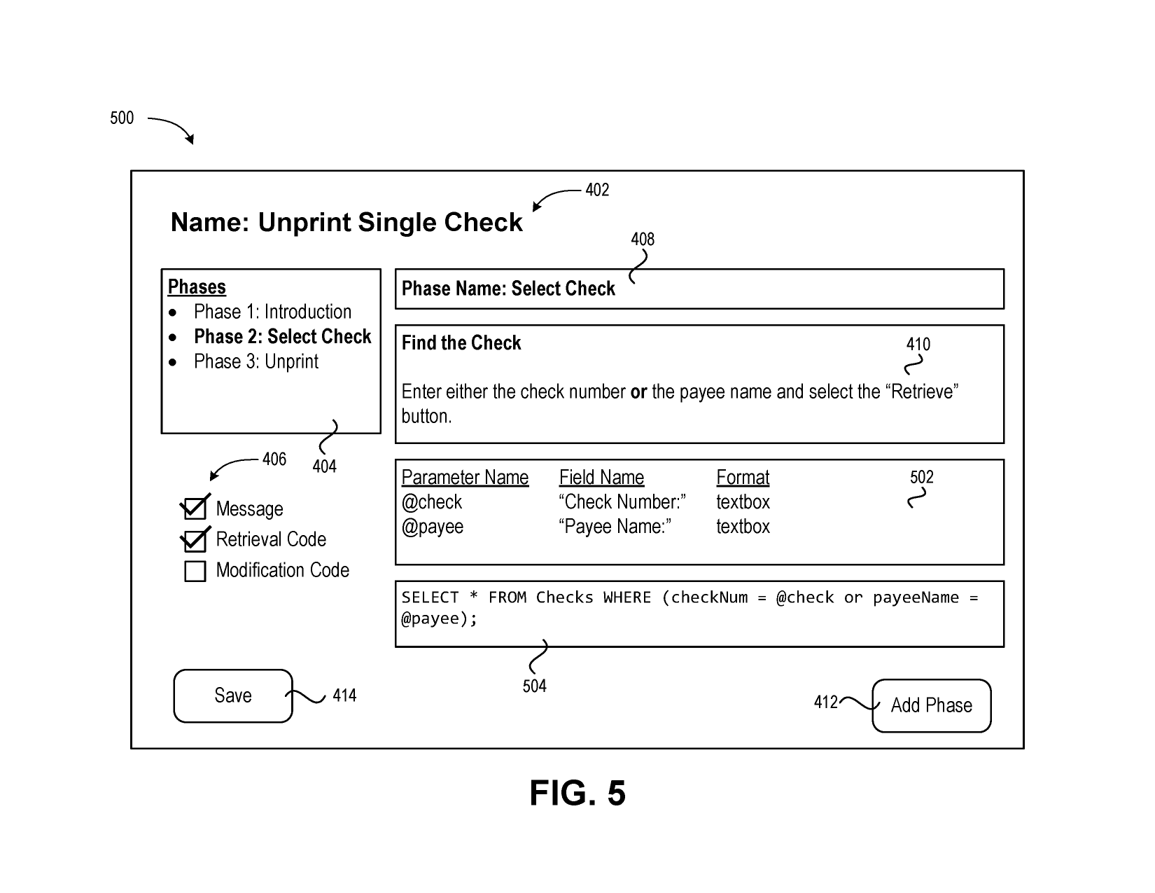

As seen in FIG. 5, the UI 500 may include a UI for authoring a second phase 302B of the custom enhancement. The UI 500 may include one or more components of the UI 400 of FIG. 4, including the name 402 of the custom enhancement, the phase UI element 404, the action selection UI element 406, the phase name UI element 408, a message input UI element 410, the add phase UI element 412, and/or the save UI element 414. In UI 500, the message input UI element 410 may include a message provided by the first user that explains the second phase 302B.

The UI 500 may further include a user input UI element 502. The user input UI element 502 may include a UI element that accepts user input from the first user of the first client device 130A that indicates one or more parameters that a second user can input during the second phase 302B. For example, as seen in FIG. 5, the user input UI element 502 may include a table with one or more columns indicating fields the first user can input, and each row can correspond to a parameter. In the example of FIG. 5, the one or more parameters include a first parameter named “@check,” which the second user can input into a text box labelled “Check Number,” and a second parameter named “@payee,” which the second user can input into a text box labeled “Payee Name.”

The UI 500 may further include a executable code UI element 504. The executable code UI element 504 may include a textbox that accepts text input from the first user. The text input can include executable code. The text input can include a description of the functionality of the executable code, and the text input can be provided to the AI inference subsystem 116 in order to generate a prompt for an AI model to generate the executable code based on the description of the functionality, as discussed above. In some embodiments, the first user can include one or more parameters of the user input UI element 502 in the executable code. For example, as seen in FIG. 5, the executable code includes the @check and @payee parameters so that the executable code can look up data in the database(s) 126 that are associated with one or more of the parameters input by a second user.

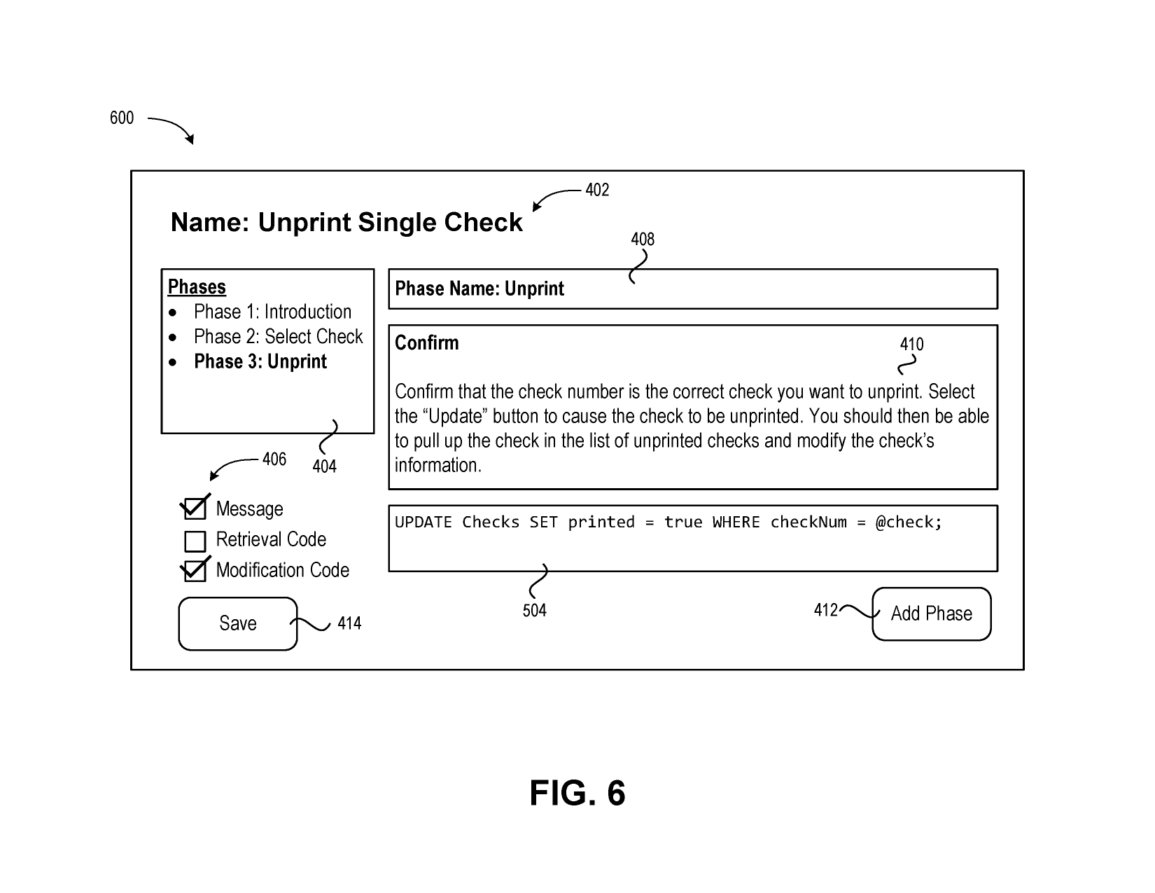

As seen in FIG. 6, the UI 600 may include a UI for authoring a third phase 302C of the custom enhancement. The UI 600 may include one or more components of the UI 400 of FIG. 4, including the name 402 of the custom enhancement, the phase UI element 404, the action selection UI element 406, the phase name UI element 408, a message input UI element 410, the add phase UI element 412, and/or the save UI element 414. In UI 600, the message input UI element 410 may include a message provided by the first user that explains the third phase 302C.

The UI 600 may further include an executable code UI element 504. The executable code UI element 504 may include a textbox that accepts text input from the first user. The text input can include executable code. The executable code may include a parameter from a previous UI 500. For example, as seen in FIG. 6, the executable code includes the @check parameter from the user input UI element 502 of the UI 500 so the executable code can modify data that in the database(s) 126 that are associated with the parameter. Responsive to the user of the first client device 130A interacting with the save UI element 414, the first client device 130A may provide the custom enhancement data generated using the UIs 400-600 to the custom enhancement subsystem 114 for storage in the data store 120.

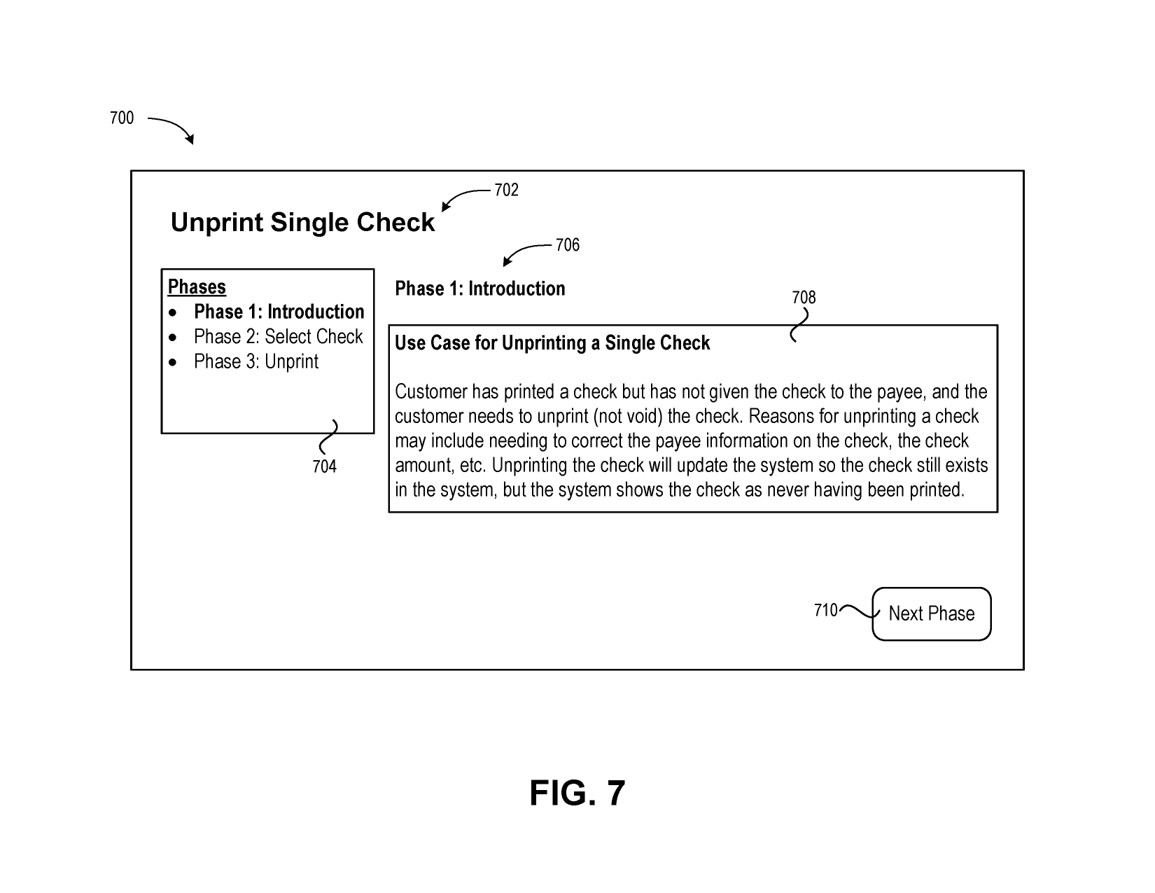

FIGS. 7-9 depict example UIs 700, 800, and 900, respectively, for end user enhancement of software services. The example UIs 700-900 may include UIs that another user of a second client device 130B can use to cause the server device 110 to perform the task of unprinting a single check. A second client device 130B of the one or more client devices 130A-N may present the UIs 700-900 on a display of the second client device 130B. The user of the second client device 130B may use the UIs 700-900 to cause the software application 112 or the custom enhancement subsystem 114 to perform the task (e.g., as discussed above in relation to blocks 230 and 240 of the method 200).

As seen in FIG. 7, the UI 700 may include a UI for the first phase 302A of the custom enhancement. The UI 700 may include the name UI element 702, which may display the name of the custom enhancement. The UI 700 may include a phase UI element 704. The phase UI element 704 may include text indicating the one or more phases 302A-C of the custom enhancement and may indicate which phase 302A the user of the second client device 130B is currently on (e.g., by bolding the name of the current phase 302A). The UI 700 may include a phase name UI element 706, which may display the name of the phase 302A of the task that the user of the second client device 130B is currently on. The UI 700 may include a message UI element 708, which may display the text that was input into the message input UI element 410 of the UI 400. The UI 700 may include a next phase UI element 710 (e.g., a button) that the user of the second client device 130B can interact with to proceed to the next phase 302B.

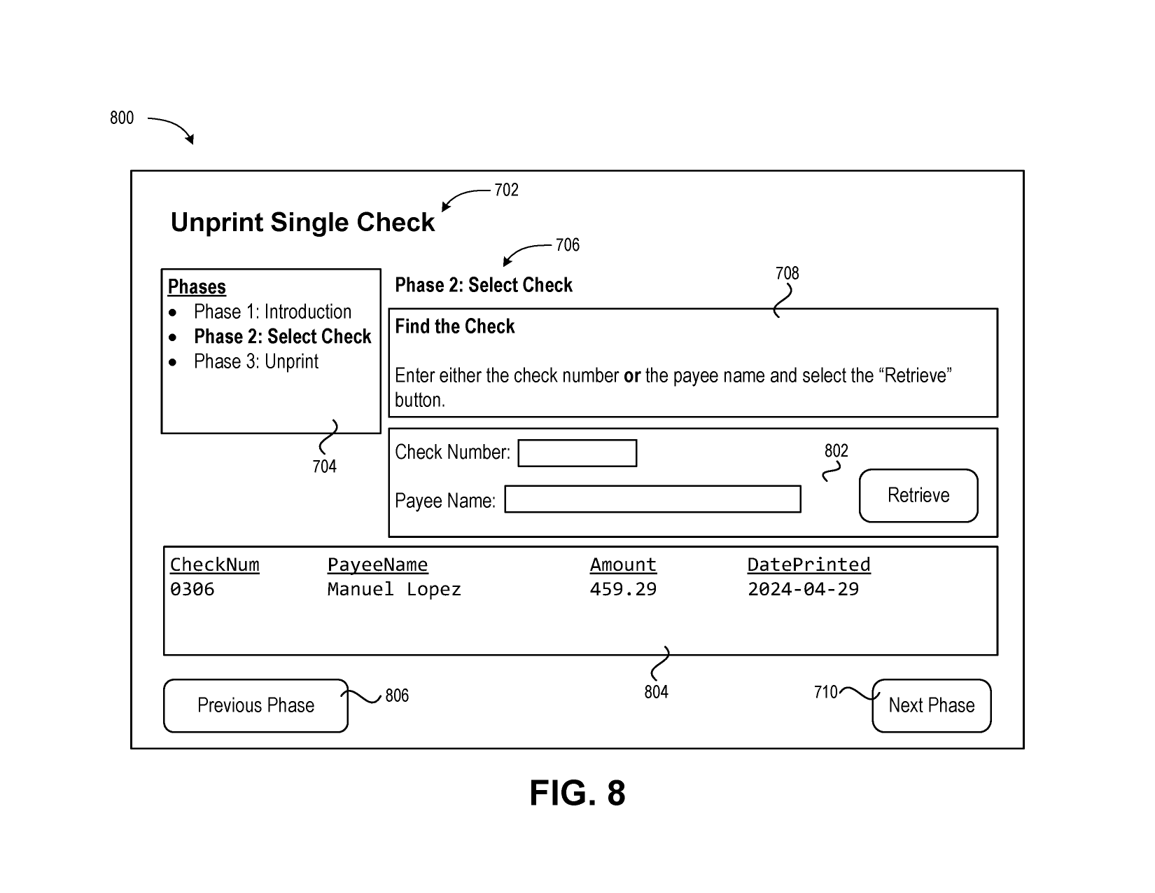

As seen in FIG. 8, the UI 800 may include a UI for the second phase 302B of the custom enhancement. The UI 800 may include one or more components of the UI 700, such as the name UI element 702, the phase UI element 704, the phase name UI element 706, the message UI element 708, and/or the next phase UI element 710. The message UI element 708 of the UI 800 may display the text input into the message input UI element 410 of the UI 500.

As also seen in FIG. 8, the UI 800 may include a user input UI element 802. The user input UI element 802 may present one or more UI elements for accepting input from the user of the second client device 130B, as indicated by the user input UI element 502 of the UI 500. For example, as seen in FIG. 8, the user input UI element 802 includes a first textbox labeled “Check Number” where the user can input a check number, and a second textbox labeled “Payee Name” where the user can input a payee’s name. The user input UI element 802 can include a retrieve UI element (e.g., a button), and interacting with the retrieve UI element can cause the software application 112 or the custom enhancement subsystem 114 to execute the portion of executable code associated with the second phase 302B, which includes the executable code input into the executable code UI element 504 of the UI 500. The executable code may use one or more of the parameters that the user of the second client device 130B input into the user input UI element 802. The UI 800 may include a result UI element 804, which may include a UI element that presents one or more results of the execution of the portion of executable code. A result of the execution of the portion of executable code may include, for example, one or more database records or other data retrieved from the data store 120. The UI 800 may include a previous phase UI element 806 (e.g., a button), and interacting with the previous phase UI element 806 may present the UI 700 of the previous phase 302A.

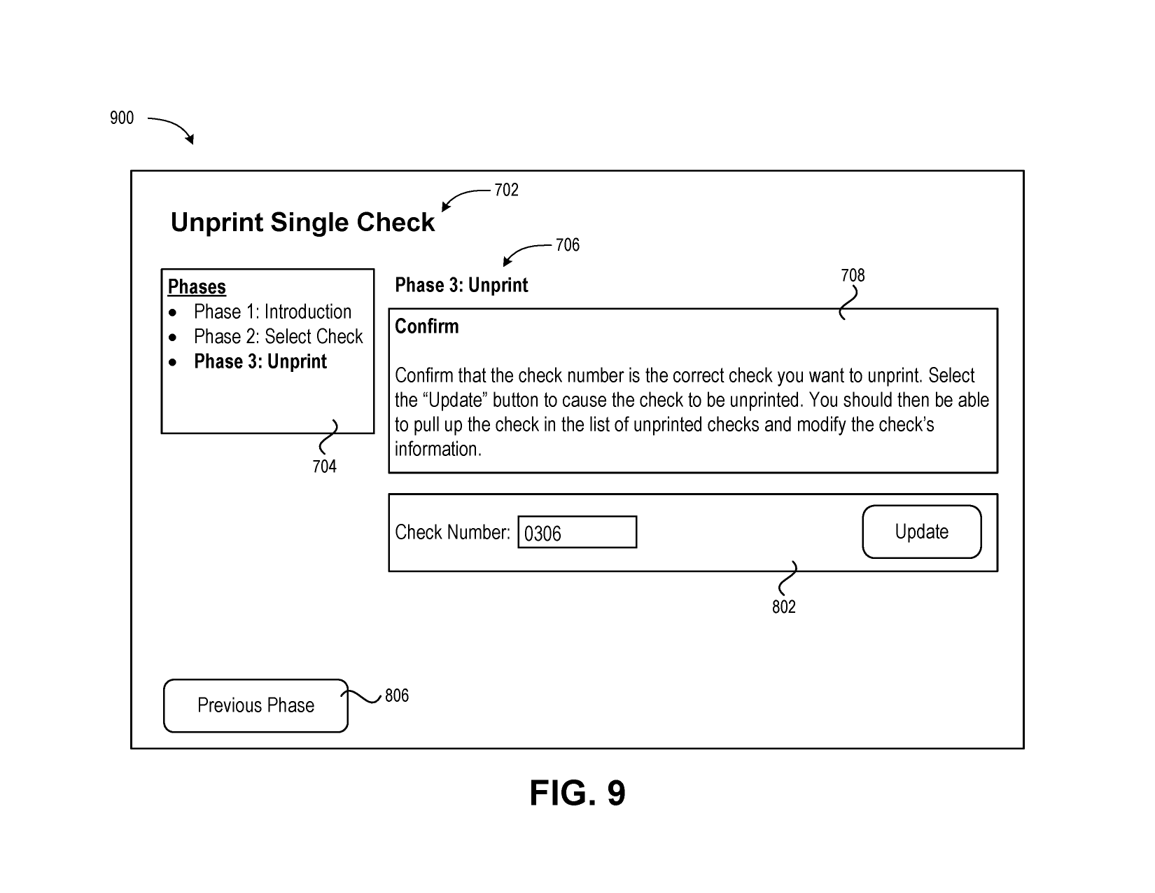

As seen in FIG. 9, the UI 900 may include a UI for the third phase 302C of the custom enhancement. The UI 900 may include one or more components of the UI 700 or the UI 800, such as the name UI element 702, the phase UI element 704, the phase name UI element 706, the message UI element 708, and the previous phase UI element 806. The message UI element 708 of the UI 900 may display the text input into the message input UI element 410 of the UI 600.

The UI 900 may include a user input UI element 802. The user input UI element 802 may present one or more UI elements for accepting input from the user of the second client device 130B. For example, as seen in FIG. 9, the user input UI element 802 includes a first textbox labeled “Check Number” where the user can input a check number. The textbox may be prepopulated with a parameter from the result UI element 804 of the previous phase 302B. The user input UI element 802 can include an update UI element (e.g., a button), and interacting with the update UI element can cause the software application 112 or the custom enhancement subsystem 114 to execute the portion of executable code associated with the third phase 302C, which includes the executable code input into the executable code UI element 504 of the UI 600. The executable code may use one or more of the parameters input into the user input UI element 802 of the UI 900.

In some embodiments, the task of the custom enhancement may include unmarking and unprinting post only instant checks, generating a log entry trace for a server error, updating a tax deduction effective date, inactivating a payroll date, changing a pay date, mass flagging imported pays as post only, deleting an individual check in a payroll batch, deleting all pays in batches by pay group, making all direct deposits to an available balance account, moving an adjustment to a prior time period, Pennsylvania tax lookup by political subdivision code, correcting a benefit date error, update a government identification number (e.g., Social Security number) in pay history, or other tasks.

In one embodiment, the custom enhancement subsystem 114 may collect telemetry data responsive to the execution of a custom enhancement of the custom enhancement data 124. Collecting telemetry data may include collecting data indicating a number of times the custom enhancement has been performed, data indicating whether performing the custom enhancement produced an error, or other data associated with performing a custom enhancement. Responsive to the performance of a custom enhancement producing an error, the custom enhancement subsystem 114 may provide a message to the user that authored the custom enhancement informing the user about the error so the user can modify the custom enhancement to prevent further errors.

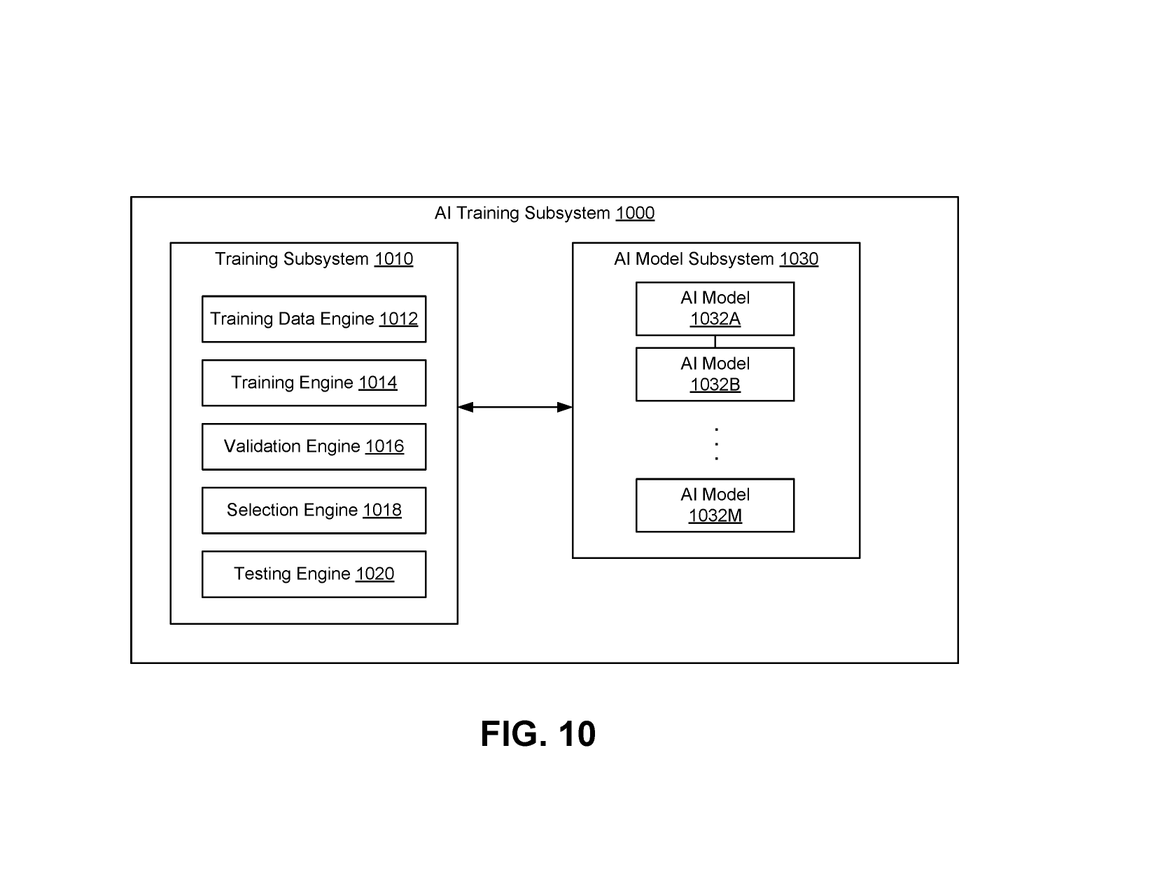

FIG. 10 illustrates an example AI training subsystem 1000, in accordance with implementations of the present disclosure. The AI training subsystem 1000 may include one or more component configured to or programmed to train one or more AI models. In some embodiments, the server device 110 may include the AI training subsystem 1000. In one embodiment, the AI training subsystem 1000 may be included on a third-party server device in data communication with the server device 110.

As illustrated in FIG. 10, the AI training subsystem 1000 may include a training subsystem 1010, which may include a training data engine 1012, a training engine 1014, a validation engine 1016, a selection engine 1018, or a testing engine 1020. The AI training subsystem 1000 may include an AI model subsystem 1030. The AI model subsystem 1030 may include one or more AI models 1032A-M.

In one embodiment, the AI model 1032A-M includes one or more of artificial neural networks (ANNs), decision trees, random forests, support vector machines (SVMs), clustering-based models, Bayesian networks, or other types of machine learning models. ANNs generally include a feature representation component with a classifier or regression layers that map features to a target output space. The ANN can include multiple nodes (“neurons”) arranged in one or more layers, and a neuron can be connected to one or more neurons via one or more edges (“synapses”). The synapses can perpetuate a signal from one neuron to another, and a weight, bias, or other configuration of a neuron or synapse can adjust a value of the signal. Training the ANN may include adjusting the weights or other features of the ANN based on an output produced by the ANN during training.

An ANN may include, for example, a convolutional neural network (CNN), recurrent neural network (RNN), or a deep neural network. A CNN, a specific type of ANN, hosts multiple layers of convolutional filters. Pooling is performed, and non-linearities may be addressed, at lower layers, on top of which a multi-layer perceptron is commonly appended, mapping top layer features extracted by the convolutional layers to decisions (e.g., classification outputs). A deep network may include an ANN with multiple hidden layers or a shallow network with zero or a few (e.g., 1-2) hidden layers. Deep learning is a class of machine learning algorithms that use a cascade of multiple layers of nonlinear processing units for feature extraction and transformation. Each successive layer uses the output from the previous layer as input. An RNN is a type of ANN that includes a memory to enable the ANN to capture temporal dependencies. An RNN is able to learn input-output mappings that depend on both a current input and past inputs. The RNN will address past and future measurements and make predictions based on this continuous measurement information. One type of RNN that can be used is a long short term memory (LSTM) neural network.

ANNs can learn in a supervised (e.g., classification) or unsupervised (e.g., pattern analysis) manner. Some ANNs (e.g., such as deep neural networks) may include a hierarchy of layers, where the different layers learn different levels of representations that correspond to different levels of abstraction. In deep learning, each level learns to transform its input data into a slightly more abstract and composite representation.

In one embodiment, an AI model 1032A-M includes a generative AI model. A generative AI model can deviate from a machine learning model based on the generative AI model’s ability to generate new, original data, rather than making predictions based on existing data patterns. A generative AI model can include a generative adversarial network (GAN), a variational autoencoder (VAE), or a large language model (LLM). In some instances, a generative AI model can employ a different approach to training or learning the underlying probability distribution of training data, compared to some machine learning models. For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

Generative AI models also have the ability to capture and learn complex, high-dimensional structures of data. One aim of generative AI models is to model underlying data distribution, allowing them to generate new data points that possess the same characteristics as training data. Some machine learning models (e.g., that are not generative AI models) focus on optimizing specific prediction of tasks.

In some embodiments, an AI model 1032A-M is an AI model that has been trained on a corpus of data. In some embodiments, the AI model 1032A-M can be a model that is first pre-trained on a corpus of data to create a foundational model, and afterwards fine-tuned on more data pertaining to a particular set of tasks to create a more task-specific, or targeted, model. The foundational model can first be pre-trained using a corpus of data that can include data in the public domain, licensed content, and/or proprietary content. Such a pre-training can be used by the AI model 1032A-M to learn broad elements including, image or speech recognition, general sentence structure, common phrases, vocabulary, natural language structure, and other elements. In some embodiments, this first, foundational model is trained using self-supervision, or unsupervised training on such datasets.

In some embodiments, the second portion of training, including fine-tuning, may be unsupervised, supervised, reinforced, or any other type of training. In some embodiments, this second portion of training includes some elements of supervision, including learning techniques incorporating human or machine-generated feedback, undergoing training according to a set of guidelines, or training on a previously labeled set of data, etc. In a non-limiting example associated with reinforcement learning, the outputs of the AI model 1032A-M while training can be ranked by a user, according to a variety of factors, including accuracy, helpfulness, veracity, acceptability, or any other metric useful in the fine-tuning portion of training. In this manner, the AI model 1032A-M can learn to favor these and any other factors relevant to users when generating a response. Further details regarding training are provided below.

In some embodiments, an AI model 1032A-M includes one or more pre-trained models, or fine-tuned models. In a non-limiting example, in some embodiments, the goal of the “fine-tuning” is accomplished with a second, or third, or any number of additional models. For example, the outputs of the pre-trained model can be input into a second AI model 1032A-M that has been trained in a similar manner as the “fine-tuned” portion of training above. In such a way, two more AI models 1032A-M can accomplish work similar to one model that has been pre-trained, and then fine-tuned.

As indicated above, an AI model 1032A-M may be one or more generative AI models 1032A-M, allowing for the generation of new and original content. The generative AI model 1032A-M can use other machine learning models including an encoder-decoder architecture including one or more self-attention mechanisms, and one or more feed-forward mechanisms. In some embodiments, the generative AI model 1032A-M includes an encoder that can encode input textual data into a vector space representation; and a decoder that can reconstruct the data from the vector space, generating outputs with increased novelty and uniqueness. The self-attention mechanism can compute the importance of phrases or words within a text data with respect to all of the text data. A generative AI model 1032A-M can also utilize the previously discussed deep learning techniques, including RNNs, CNNs, or transformer networks. Further details regarding generative AI models 1032A-M are provided herein.

In some embodiments, different AI models 1032A-M of the one or more AI models 1032A-M are different types of AI models 1032A-M. Multiple AI models 1032A-M of the one or more AI models 1032A-M can form an ensemble.

In one embodiment, the training subsystem 1010 manages the training and testing of the one or more AI models 1032A-M. The training data engine 1012 can generate training data (e.g., a set of training inputs and a set of target outputs) to train an AI model 1032A-M. In an illustrative example, the training data engine 1012 can initialize a training set T to null. The training data engine 1012 can add the training data to the training set T and can determine whether training set T is sufficient for training the AI model 1032A-M. The training set T can be sufficient for training the AI model 1032A-M if the training set T includes a threshold amount of training data, in some embodiments. In response to determining that the training set T is not sufficient for training, the training data engine 1012 can identify additional training data and add it to the training set T. In response to determining that the training set T is sufficient for training, the training data engine 1012 can provide the training set T to the training engine 1014. A piece of training data may include a portion of executable code.

The training engine 1014 can train the AI model 1032A-M using the training data (e.g., training set T). The AI model 1032A-M can refer to the model artifact that is created by the training engine 1014 using the training data, where such training data can include training inputs and, in some embodiments, corresponding target outputs (e.g., correct answers for respective training inputs). The training engine 1014 can input the training data into the AI model 1032A-M so that the AI model 1032A-M can find patterns in the training data and configure itself based on those patterns.

Where the AI model 1032A-M uses supervised learning, the training engine 1014 can assist the AI model 1032A-M in determining whether the AI model 1032A-M maps the training input to the target output (the answer to be predicted). Where the AI model 1032A-M uses unsupervised learning, the training engine 1014 can input the training data into the AI model 1032A-M. The AI model 1032A-M can configure itself based on the input training data, but since the training data may not include a target output, the training engine 1014 may not assist the AI model 1032A-M in determining whether the AI model 1032A-M provided a correct output during the training process.

The validation engine 1016 may be capable of validating a trained AI model 1032A-M using a corresponding set of features of a validation set from the training data engine 1012. The validation engine 1016 can determine an accuracy of each of the trained AI models 1032A-M based on the corresponding sets of features of the validation set. Where the training data may not include a target output, validating a trained AI model 1032A-M may include obtaining an output from the AI model 1032A-M and providing the output to another entity for evaluation. The other entity may include another AI model configured to evaluate the output of the AI model that is undergoing training. The other entity may include a human. The validation engine 1016 can discard a trained AI model 1032A-M that has an accuracy that does not meet a threshold accuracy or that otherwise fails evaluation. In some embodiments, the selection engine 1018 is capable of selecting a trained AI model 1032A-M that has an accuracy that meets a threshold accuracy. In some embodiments, the selection engine 1018 is capable of selecting the trained AI model 1032A-M that has the highest accuracy of multiple trained AI models 1032A-M. In some embodiments, the selection engine 1018 obtains input from another AI model or a human and can select a trained AI model 1032A-M based on the input.

The testing engine 1020 may be capable of testing a trained AI model 1032A-M using a corresponding set of features of a testing set from the training data engine 1012. For example, a first trained AI model 1032A-M that was trained using a first set of features of the training set may be tested using the first set of features of the testing set. The testing engine 1020 can determine a trained AI model 1032A-M that has the highest accuracy or other evaluation of all of the trained AI models 1032A-M based on the testing sets.

As described above, the AI training subsystem 1000 can be configured to train an LLM. It should be noted that the AI training subsystem 1000 can train an LLM in accordance with implementations described herein or in accordance with other techniques for training LLMs. For example, an LLM may be trained on a large amount of data, including prediction of one or more missing words in a sentence, identification of whether two consecutive sentences are logically related to each other, generation of next texts based on prompts, etc.

In some embodiments, the AI model subsystem 1030 selects an AI model 1032A-M from the one or more AI models 1032A-M. Selecting an AI model 1032A-M may include selecting the AI model 1032A-M for training or for use. For example, the training subsystem 1010 can provide data to the AI model subsystem 1030 indicating which AI model 1032A-M is to be trained. The AI model subsystem 1030 can obtain data from a component of the custom enhancement subsystem 114 indicating which AI model 1032A-M to use to generate output.

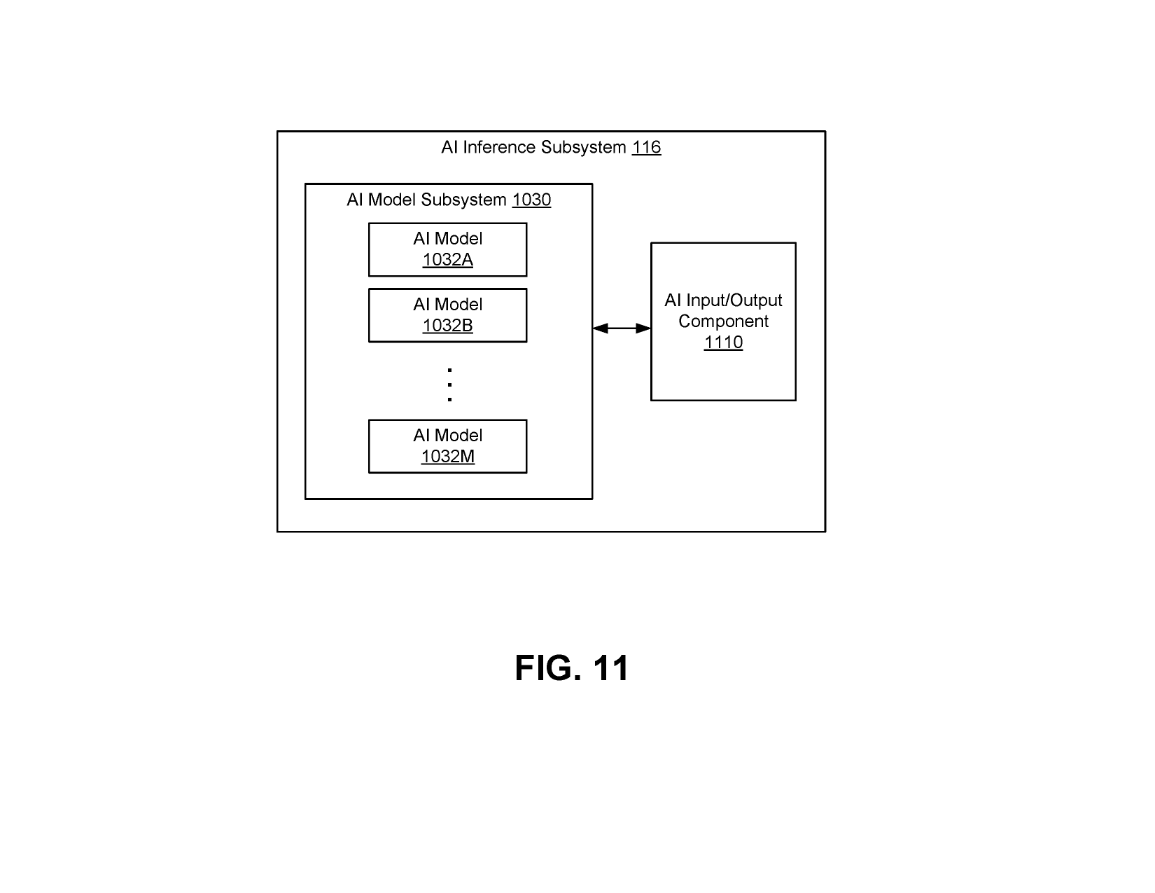

FIG. 11 depicts one embodiment of an AI inference subsystem 116. The AI inference subsystem 116 may include one or more components configured to or programmed to provide input to one or more AI models, obtain output from the one or more AI models, and provide the output to other components of the system 100 (e.g., the custom enhancement subsystem 114).

In some embodiments, the AI inference subsystem 116 may include the AI model subsystem 1030, which may include one or more AI models 1032A-M. In other embodiments, the AI model subsystem 1030 may be located on a third-party server that is in data communication with the AI inference subsystem 116. The AI inference subsystem 116 may include an AI input/output component 1110. The AI input/output component 1110 may be configured to feed data as input to an AI model 1032A-M and obtain one or more outputs. In such implementations, the AI input/output component 1110 feeds a description of the functionality of a portion of executable code as input to an AI model 1032A-M and obtain one or more outputs.

As an example, as discussed above, the first user of the first client device 130A may input a description of the functionality of the executable code into the executable code UI element 504 of the UI 500 of FIG. 5, and the first client device 130A send the description to the AI inference subsystem 116. The AI subsystem may provide the description to the AI input/output component 1110. The AI input/output component 1100 may use the description to generate a generative AI prompt based on the description and provide the generative AI prompt to the AI model subsystem 1030. An AI model 1032A of the AI model subsystem 1030 may generate the portion of executable code based on the generative AI prompt and may provide the portion of executable code to the AI input/output component 1110. The AI input/output component 1110 may provide the portion of executable code to the first client device 130A for presentation to the first user.

As indicated above, an AI model 1032A-M may include a generative AI model 1032A-M, such as an LLM. In some embodiments, the generative AI model 1032A-M includes generative AI functionality. In such embodiments, the AI model 1032A-M generates new content based on provided input data. The input data may include a description of the functionality of a portion of executable code.

In some embodiments, the generative AI model 1032A-M is supported by a prompt subsystem. The prompt subsystem may be part of the AI inference subsystem 116. For example, the prompt subsystem may be in data communication with the AI input/output component 1110, or the prompt subsystem may be part of the AI input/output component 1110.

The prompt subsystem can enable the AI input/output component 1110 to access a generative AI model 1032A-M. The prompt subsystem may be configured to perform automated identification of, and facilitate retrieval of, relevant and timely contextual information for efficient and accurate processing of prompts. Using the network 140 (or another network), the prompt subsystem may be in communication with one or more of the server devices 110 or the data store 120. Communications between the prompt subsystem and the AI input/output component 1110 may be facilitated by a generative model API, in some embodiments. Communications between the prompt subsystem and the server device 110 or the data store 120 may be facilitated by a data management API. In additional or alternative embodiments, the generative model API translates prompts generated by the prompt subsystem into unstructured natural-language format and, conversely, translate responses received from the AI model 1032A-M into any suitable form (e.g., including any structured proprietary format as may be used by the prompt subsystem). Similarly, the data management API can support instructions that may be used to communicate data requests to server device 110 or the data store 120 and formats of data received from such components.

In some embodiments, the prompt subsystem includes a prompt analyzer to support various operations of this disclosure. For example, the prompt analyzer can receive an input (e.g., a prompt submitted by the AI input/output component) and generate one or more intermediate prompts to the generative AI model 1032A-M to determine what type of data the generative AI model 1032A-M may need to successfully respond to the input. Upon receiving a response from the generative AI model 1032A-M, the prompt analyzer can analyze the response, form a request for relevant contextual data for the data store 120, which can then supply such data. The prompt analyzer can then generate a prompt to the generative AI model 1032A-M that includes the original prompt and the contextual data. In some embodiments, the prompt analyzer, itself, includes a lightweight generative AI model that can process the intermediate prompt(s) and determine what type of contextual data may be needed by the generative AI model 1032A-M together with the original prompt to ensure a meaningful response from generative AI model 1032A-M.

The prompt subsystem may include (or may have access to) instructions stored on one or more tangible, machine-readable storage media of a computing device (e.g., the server device 110) and executable by one or more processing devices of the computing device. In one embodiment, the prompt subsystem is implemented on a single machine. In some embodiments, the prompt subsystem is combination of a client component and a server component. In some embodiments, the prompt subsystem is executed entirely on a client device 130A-N. Alternatively, some portion of the prompt subsystem may be executed on a client computing device while another portion of the prompt subsystem may be executed on a server.

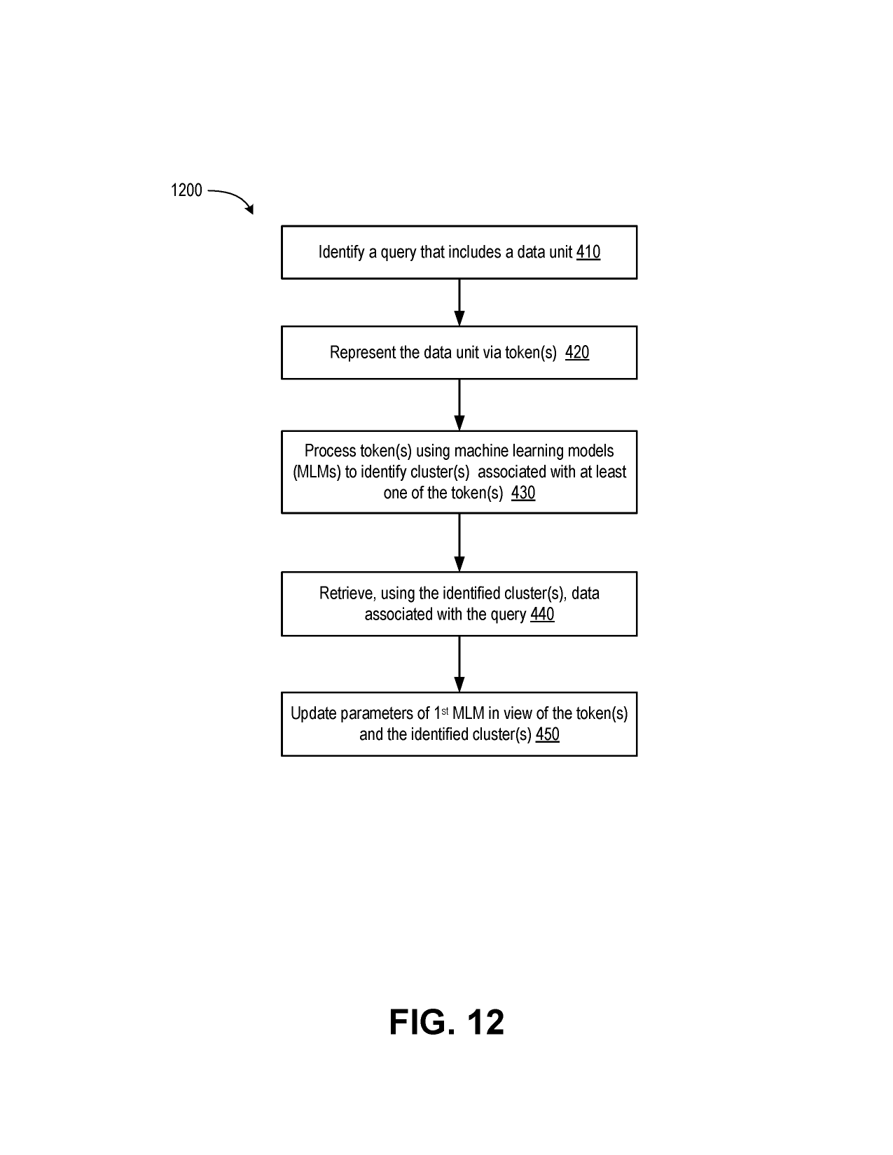

FIG. 12 illustrates an example method 1200 for providing error-avoidance data, in accordance with one or more embodiments of the present disclosure. A processing device, having one or more CPU(s), one or more GPU(s), and/or memory devices communicatively coupled to the one or more CPU(s) and/or GPU(s) can perform the method 1200 and/or one or more of the method’s 1200 individual functions, routines, subroutines, or operations. In certain embodiments, a single processing thread can perform the method 1200. Alternatively, two or more processing threads can perform the method 1200, each thread executing one or more individual functions, routines, subroutines, or operations of the method. In an illustrative example, the processing threads implementing the method 1200 can be synchronized (e.g., using semaphores, critical sections, and/or other thread synchronization mechanisms). Alternatively, the processing threads implementing the method 1200 can be executed asynchronously with respect to each other. Various operations of the method 1200 can be performed in a different (e.g., reversed) order compared with the order shown in FIG. 12. Some operations of the method 1200 can be performed concurrently with other operations. Some operations can be optional. In some embodiments, the software application 112 or the custom enhancement subsystem 114 performs one or more of the operations of the method 1200. While the below method 1200 discusses actions of the software application 112, the method 1200 is also applicable to actions of the custom enhancement subsystem 114.

At block 1210, processing logic obtains a first activity log. The first activity log may include data indicating one or more first actions caused by a first user of a first computing device while using the software application 112. The first activity log may include data indicating an error produced by the software application 112. For example, the first user may use the first client device 130A to cause the software application 112 to perform one or more first actions. The one or more actions may include accepting user input, retrieving data from the data store 120, processing data, or other actions performable by the software application 112. The one or more first actions may include a series of actions performed by the software application 112. Performing the one or more first actions may result in the software application 112 producing an error.

At block 1220, processing logic identifies a second activity log that includes data indicating one or more second actions caused by a second user of a second computing device while using the software application 112. The one or more first actions may be within a threshold similarity to the one or more second actions. The second activity log may be free of the error indicated in the first activity log. In one embodiment, the threshold similarity may include a predetermined portion of the one or more second actions matching one or more second actions. The predetermined portion may include 50% of the one or more second actions, 60%, 70%, or another portion. In one embodiment, the server device 110 may generate a first vector embedding based on the one or more first actions, generate a second vector embedding based on the one or more second actions, and determine a distance between the first vector and the second vector in a vector space. The one or more first actions may be within a threshold similarity to the one or more second actions responsive to the distance between the first vector and the second vector being below a threshold distance.

At block 1230, processing logic identifies an action of the one or more second actions as a point of divergence from the one or more first actions. As discussed above, the one or more first actions and the one or more second actions may each include a respective series of actions. The software application 112 may determine at which action the two series of actions differ and identify the different action of the one or more second actions as the point of divergence.

At block 1240, processing logic causes a UI of the first computing device to present a message based on the action of the one or more second actions as the point of divergence. The software application 112 may generate a message that includes information about the point of divergence action. The information may include a different user input that was provided, a different configuration of the software application 112, a different option that was selected in the software application 112, or some other data that is different between the action of the one or more second actions and the one or more first actions. The software application 112 may send the message to the first client device 130A to be included in an error message presented on the UI of the first client device 130A.

FIG. 13 depicts an example computer system 1300 that can perform any one or more of the methods described herein, in accordance with some embodiments of the present disclosure. The computer system may be connected (e.g., networked) to other computer systems in a LAN, an intranet, an extranet, or the Internet. The computer system may operate in the capacity of a server in a client-server network environment. The computer system may be a personal computer (PC), a tablet computer, a set-top box (STB), a Personal Digital Assistant (PDA), a mobile phone, a camera, a video camera, or any device capable of executing a set of instructions (sequential or otherwise) that specify actions to be taken by that device. Further, while only a single computer system is illustrated, the term “computer” shall also be taken to include any collection of computers that individually or jointly execute a set (or multiple sets) of instructions to perform any one or more of the methods discussed herein.

The exemplary computer system 1300 includes a processing device 1302, a main memory 1304 (e.g., read-only memory (ROM), flash memory, dynamic random access memory (DRAM) such as synchronous DRAM (SDRAM)), a static memory 1306 (e.g., flash memory, static random access memory (SRAM)), and a data storage device 1318, which communicate with each other via a bus 1330.

Processing device 1302 (which can include processing logic 1303) represents one or more general-purpose processing devices such as a microprocessor, central processing unit, or the like. More particularly, the processing device 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 1302 may also be one or more special-purpose processing devices such as an application specific integrated circuit (ASIC), a field programmable gate array (FPGA), a digital signal processor (DSP), network processor, or the like. The processing device 1302 is configured to execute instructions 1322 for implementing the custom enhancement subsystem 114 and to perform the operations discussed herein (e.g., the methods 200 or 1200).

The computer system 1300 may further include a network interface device 1308. The computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1316 (e.g., a speaker). In one illustrative example, the video display unit 1310, the alphanumeric input device 1312, and the cursor control device 1314 may be combined into a single component or device (e.g., an LCD touch screen).

The data storage device 1318 may include a computer-readable storage medium 1324 on which is stored the instructions 1322 embodying any one or more of the methodologies or functions described herein. The instructions 1322 may also reside, completely or at least partially, within the main memory 1304 and/or within the processing device 1302 during execution thereof by the computer system 1300, the main memory 1304 and the processing device 1302 also constituting computer-readable media. In some implementations, the instructions 1322 may further be transmitted or received over a network 1320 via the network interface device 1308.

While the computer-readable storage medium 1324 is shown in the illustrative examples to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

Although the operations of the methods herein are shown and described in a particular order, the order of the operations of each method may be altered so that certain operations may be performed in an inverse order or so that certain operations may be performed, at least in part, concurrently with other operations. In certain implementations, instructions or sub-operations of distinct operations may be in an intermittent and/or alternating manner.

It is to be understood that the above description is intended to be illustrative, and not restrictive. Many other implementations will be apparent to those of skill in the art upon reading and understanding the above description. The scope of the disclosure should, therefore, be determined with reference to the appended claims, along with the full scope of equivalents to which such claims are entitled.

In the above description, numerous details are set forth. It will be apparent, however, to one skilled in the art, that the aspects of the present disclosure may be practiced without these specific details. In some instances, well-known structures and devices are shown in block diagram form, rather than in detail, in order to avoid obscuring the present disclosure.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “determining,” “selecting,” “storing,” “analyzing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear as set forth in the description. In addition, aspects of the present disclosure are not described with reference to any particular programming language. It will be appreciated that a variety of programming languages may be used to implement the teachings of the present disclosure as described herein.

Aspects of the present disclosure may be provided as a computer program product, or software, which may include a machine-readable medium having stored thereon instructions, which may be used to program a computer system (or other electronic devices) to perform a process according to the present disclosure. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read-only memory (“ROM”), random access memory (“RAM”), magnetic disk storage media, optical storage media, flash memory devices, etc.).

The words “example” or “exemplary” are used herein to mean serving as an example, instance, or illustration. Any aspect or design described herein as “example” or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” or “an implementation” or “one implementation” throughout is not intended to mean the same implementation or implementation unless described as such. Furthermore, the terms “first,” “second,” “third,” “fourth,” etc. as used herein are meant as labels to distinguish among different elements and may not necessarily have an ordinal meaning according to their numerical designation.

Whereas many alterations and modifications of the disclosure will no doubt become apparent to a person of ordinary skill in the art after having read the foregoing description, it is to be understood that any particular implementation shown and described by way of illustration is in no way intended to be considered limiting. Therefore, references to details of various implementations are not intended to limit the scope of the claims, which in themselves recite only those features regarded as the disclosure.

What is claimed is:

1. A method, comprising:
obtaining, from a first client device of a first user associated with a first entity, first custom enhancement data indicating one or more phases for performing a task defined by the first user, wherein:
a first phase of the one or more phases is associated with a portion of executable code provided by the first client device, and
the portion of the executable code operates on data managed by a software application executing on a server device that is in data communication with the first client device and is associated with a second entity;
storing, by the server device, the first custom enhancement data;
obtaining, from a second client device of a second user associated with the first entity, data indicating user selection of the first custom enhancement data; and
performing, by the server device and using the first custom enhancement data, the one or more phases of the task defined by the first user for the second user, wherein performing the one or more phases of the task comprises executing the portion of executable code associated with the first phase of the one or more phases.

2. The method of claim 1, wherein the portion of executable code comprises executable code for retrieving the data managed by the software application executing on the server device.

3. The method of claim 1, wherein the portion of executable code comprises executable code for modifying the data managed by the software application executing on the server device.

4. The method of claim 1, wherein the portion of executable code comprises at least one of:
a database query;
programming instructions in a scripting language; or
machine code.

5. The method of claim 1, wherein a second phase of the one or more phases comprises instructions causing a message to be displayed on a user interface of the first client device.

6. The method of claim 5, wherein performing, by the server device, the one or more phases of the task defined by the first user comprises performing the second phase before the first phase.

7. The method of claim 1, further comprising:
receiving, from the first client device, text data comprising a command to generate executable code;
providing, to a generative AI model, a prompt based on the text data;
obtaining, from the generative AI model, the portion of executable code; and
providing the portion of executable code to the first client device.

8. The method of claim 1, wherein:
the task comprises unprinting a check; and
the first phase of the one or more phases comprises identifying data indicating the check to be unprinted, and a second phase of the one or more phases comprises modifying the data indicating the check to be unprinted to indicate that the check has not been printed.

9. The method of claim 1, the first entity is a customer of the second entity.

10. A system, comprising:
a memory; and
a processing device, coupled to the memory, configured to perform operations comprising:
obtaining, from a first client device of a first user associated with a first entity, first custom enhancement data indicating one or more phases for performing a task defined by the first user, wherein:
a first phase of the one or more phases is associated with a portion of executable code provided by the first client device, and
the portion of the executable code operates on data managed by a software application executing on a server device that is in data communication with the first client device and is associated with a second entity,
storing, by the server device, the first custom enhancement data,
obtaining, from a second client device of a second user associated with a third entity, data indicating user selection of the first custom enhancement data, and
performing, by the server device and using the first custom enhancement data, the one or more phases of the task defined by the first user for the second user, wherein performing the one or more phases of the task comprises executing the portion of executable code associated with the first phase of the one or more phases.

11. The system of claim 10, wherein the portion of executable code comprises executable code for retrieving the data managed by the software application executing on the server device.

12. The system of claim 10, wherein the portion of executable code comprises executable code for modifying the data managed by the software application executing on the server device.

13. The system of claim 10, wherein the portion of executable code comprises at least one of:
a database query;
programming instructions in a scripting language; or
machine code.

14. The system of claim 10, wherein a second phase of the one or more phases comprises instructions causing a message to be displayed on a user interface of the first client device.

15. The system of claim 14, wherein performing, by the server device, the one or more phases of the first custom enhancement data comprises performing the second phase before the first phase.

16. The system of claim 10, further comprising:
receiving, from the first client device, text data comprising a command to generate executable code;
providing, to a generative AI model, a prompt based on the text data;
obtaining, from the generative AI mode, the portion of executable code; and
providing the portion of executable code to the first client device.

17. The system of claim 10, wherein the task comprises updating a tax deduction effective date.

18. The system of claim 10, wherein the first entity and the third entity are customers of the second entity.

19. A method, comprising:
obtaining a first activity log, wherein the first activity log comprises data indicating:
a first plurality of actions caused by a first user of a first computing device while using a software application, and
an error produced by the software application;
identifying a second activity log comprising data indicating a second plurality of actions caused by a second user of a second computing device while using the software application, wherein:
the first plurality of actions is within a threshold similarity to the second plurality of actions, and
the second activity log is free of the error indicated in the first activity log;
identifying an action of the second plurality of actions as a point of divergence from the first plurality of actions; and
causing a user interface of the first computing device to present a message based on the action of the second plurality of actions as the point of divergence.
